(19) United States
(12) Patent Application Publication
(10) Pub. No.: US 2003/0104123 A1
(43) Pub. Date: Jun. 5, 2003

(54) SLIT COATING METHOD AND METHOD OF MANUFACTURING COLOR FILTER SUBSTRATE USING SAME

(76) Inventors: SATOSHI KOKUBO, KAWASAKI-SHI (JP); TOSHIAKI YOSHIKAWA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/471,160

(22) Filed: Dec. 23, 1999

(30) Foreign Application Priority Data
Dec. 28, 1998 (JP) 10-373803

(51) Int. Cl. B05D 5/06

(52) U.S. Cl. 427/162

(57) ABSTRACT

In a method for coating a member with a coating liquid during moving relatively a coating head and the member often ejecting the coating liquid over a surface of the member, a supply of coating liquid to the coating head is stopped. And, then the coating head is rinsed. The rinsing liquid flows directly to or toward the coating head, from midway of a coating liquid supply path extending to the coating head, thereby improving an efficiency of cleaning and maintenance of the coating head.

### BACKGROUND OF THE INVENTION

1. Field of the Invention

The present invention relates to a method of and a device for coating a coating liquid over the surface of a member to be coated by relatively moving a coating head and the member to be coated. The coating method and coating device are used preferably for manufacturing a color filter used especially for a color TV, a personal computer, etc.

2. Related Background Art

There have hitherto existed a dye method, a pigment dispersion method, an electrocoating method, a printing method, etc. as a method of manufacturing a color filter. According to those methods, it is required that the same process be repeated for coloring in three colors R, G and B, and a yield decreases because of a large number of processes, resulting in a rise in costs.

Further, the electrocoating method has a limit in terms of configurations of patterns which can be formed, and thus has a difficulty of being applied to a TFT. The printing method is low of resolution and hard to correspond to hyperfine patterns.

Such being the case, there is proposed a technology (disclosed in Japanese Patent Application Laid-Open No. 59-75205 etc.) of forming a pattern of the filter by ejecting inks on a glass substrate in order to compensate those defects. According to this technology, pixels in three colors R, G and B are formed simultaneously, and hence the number of processes can be significantly reduced. Based on this technology, however, R, G and B color depictions are made in a droplet state, and therefore there might occur such a phenomenon that the respective colors are mixed with each other.

For preventing the color mixing described above, Japanese Patent Application Laid-Open No. 8-75916 discloses a technology in which a substrate is formed with a resin or resinous composition layer (an ink receptor layer) exhibiting an ink receiving property which decreases with its hardening due to the light, heat, etc., or with a hydrophilic radical residual quantity being reduced, and with a color mixing preventive layer (an ink repellent layer) to obtain an ink repellent property by hardening at least a part of non-pixel areas between the pixels or decreasing the hydrophilic radial residual quantity, and decoloring of the self-pixel and an ink blur or color mixing in the adjacent pixels are thereby prevented.

Further, in the process of manufacturing the color filter, other than the ink receptor layer described above, a protection layer (an over-coat) for protecting the colored surface is composed of a resin. Moreover, a photosensitive layer for etching the black matrix for enhancing both a contrast and colorfulness when displayed by use of the color filter described above, is also composed of a resin, and the black matrix itself might be composed of a resin (resin matrix).

Incidentally, a spinner and a slit coater are known as a coating device for forming such a resin layer or other resin layers. The slit coater has an advantage of showing a less futility of the coating liquid than by the spinner. The slit coater further has an advantage in which a circuit, extending to the tip of the coating head, for supplying the coating liquid is all a closed system. The coating liquid is, however, exposed to the outside air at an opening of the slit at the tip of the head, and hence the coating liquid at the tip of the head tends to be easily dried. Another defect is that the solidified component of the coating liquid might cause clogging of a slit nozzle and stripes on the coated layer, thereby inducing a decline of a coating quality. Further, if such a defect occurs, there might often arise a case where the coating head is required to be removed from the device body and cleaned in a de-assembled state. When it is cleaned in the de-assembled state, a considerable period of time is needed until it returns from the halt of the device, and therefore a decrease in working ratio is not ignorable.

In the prior art coating device (slit coater) shown in FIG. 4, it is inevitable to prevent the coating liquid from being solidified at the tip of the coating head 5. Hence, according to the prior art, if a stop time elongates, a rinsing liquid (such as a solvent of the coating liquid) is flowed from a liquid supply circuit. Areas where the rinsing is actually needed are mainly the tip area of the coating head 5 and a slit area 54, so that it must be more of waste of the coating liquid to fill all the coating circuits with the rinsing liquid and to be again replaced with the coating liquid when returned. In addition, it takes much time to perform the rinsing process and the return process of replacing again the rinsing liquid with the coating liquid. Referring to FIG. 4, there are shown a coated layer 6, a member to be coated 7, a carrier stage 8, a coating liquid tank 11, a pipe 12, an opening/closing valve 13, a filter 14, and a quantitative pump 15.

### SUMMARY OF THE INVENTION

It is a primary object of the present invention, which was devised to obviate the problems inherent in the prior art described above, to enhance an operability and to reduce an operation time when rinsing a coating head based on a slit coat method and when performing a maintenance thereof.

It is another object of the present invention to provide a coating method and a coating device that are capable of reducing quantities of coating liquid used and of rinsing liquid used, decreasing a defect in coating due to a solidified coating liquid at the tip of a coating head, thus exhibiting an excellent quality and reducing the costs.

To accomplish the above objects, according to one aspect of the present invention, a coating method of ejecting a coating liquid over the surface of a member to be coated and thus forming a coated layer thereon by relatively moving a coating head and the member to be coated, comprises a step of rinsing the coating head by stopping a supply of the coating liquid to the coating head after ejecting the coating liquid, and allowing a rinsing liquid to flow directly to the coating head.

According to another aspect of the present invention, a coating device comprises a coating liquid supply device, a coating head for discharging a coating liquid supplied from the coating liquid supply device, and a stage for holding a member to be coated, wherein a first liquid circuit for supplying the coating liquid and a second liquid circuit for supplying a rinsing liquid to the coating head are provided.

According to the present invention, the path for supplying the rinsing liquid is partially or entirely separated from the path for supplying the coating liquid. With this contrivance, it may be sufficient to make the replacement between the coating liquid and the rinsing liquid when in the coating process and in the case other than this coating process with respect to only the supply path common to the coating liquid and the inside of the coating head. It is therefore feasible to reduce a quantity of the rinsing liquid replaced for coating and discharged, and a quantity of the coating liquid replaced for rinsing and discharged.

Further, if the coating process, the rinsing process or the leave-as-it-is process is automatically implemented by switching a valve, an operability in the case of effecting the rinsing and a maintenance can be enhanced, and an operation time can be reduced.

Moreover, when left as it is, the coating head is prevented from being dried by flowing the rinsing liquid in place of the coating liquid trace by trace or intermittently, whereby a defect in coating due to the solidification of the coating liquid at the tip of the coating head is decreased, and a coated layer having a high quality can be formed at a low cost.

### BRIEF DESCRIPTION OF THE DRAWINGS

FIG. 1 is a diagram showing one example of a coating device according to the present invention;

FIGS. 2A, 2B, 2C, 2D and 2E are diagrams showing processes of a method of manufacturing a color filter substrate according to the present invention by way of one example thereof;

FIG. 3 is a sectional view showing one example of a liquid crystal display device of the present invention;

FIG. 4 is a diagram showing one example of a prior art coating device; and

FIG. 5 is a diagram showing how stripes as a defect are formed in the prior art coating device.

### DETAILED DESCRIPTION OF THE PREFERRED EMBODIMENTS

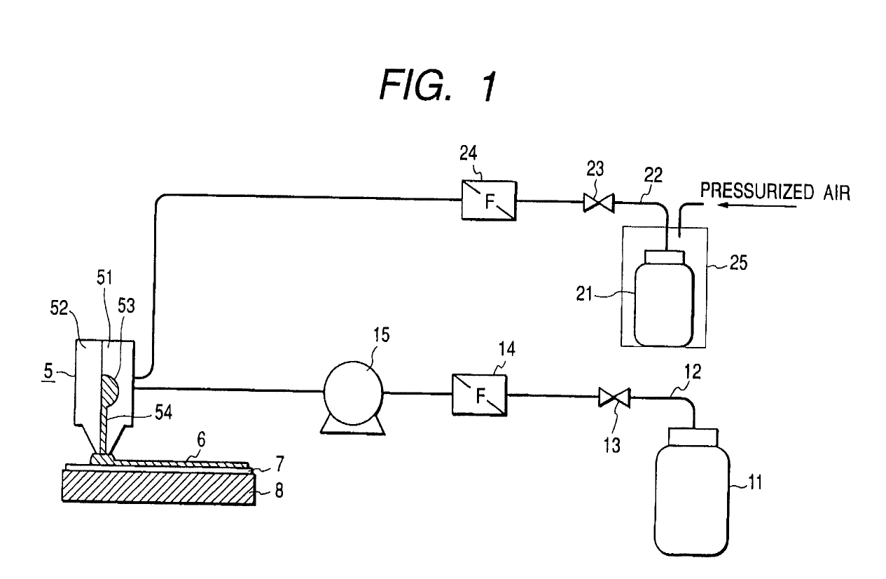

Preferred embodiments of the present invention will hereinafter be described in depth with reference to the accompanying drawings. FIG. 1 is a schematic diagram showing one example of a coating device by which a coating method of the present invention is carried out. A coating liquid is supplied by a quantitative pump 15 from a coating liquid tank 11 via a first liquid circuit to a coating head 5. This quantitative pump is defined as a volumetric pump such as a gear pump, a diaphragm pump and a syringe pump. Further, a coating liquid supply mechanism other than the pump may be such a type that the coating liquid tank is put in a pressurizing container supplied with a gas (air, nitrogen, etc.) pressurized by a pressurizing pump, thereby pushing the coating liquid out.

Moreover, an opening/closing valve 13 and a filter 14 may be provided-on a route along a pipe 12 extending from the coating liquid tank 11 to the quantitative pump 15 as the necessity may arise.

A rinsing liquid is supplied to the coating head 5 via an opening/closing valve 23 from a rinsing liquid tank 21 encased in the pressurizing container 25 (a second liquid circuit). The gas (air, nitrogen, etc.) pressurized by a pressurizing pump (not shown) is supplied to the pressurizing container 25, thereby pushing the rinsing liquid out.

Any type of pumps generally used for supplying the liquid by pressure are usable for supplying the ringing liquid in addition to the gas pressurizing type described above.

Further, a filter 24 may be provided on the route along a pipe 22 according to the necessity.

The coating head 5 constructed of a front lip 51 and a rear lip 52 is formed with a coating liquid supply port and provided with a manifold 53 for uniformizing a pressure distribution of the coating liquid during a flow of the coating liquid from the coating liquid supply port down to a coating liquid slit 54. It is preferable that a slip gap (a gap between the front and rear lips 51, 52) of a slit 54 be on the order of 10 μm-200 μm.

A member to be coated 7 is disposed in a face-to-face relationship with the coating head 5 through a fixed clearance. This clearance preferably falls within a range of 500 μm-20 μm.

The member to be coated 7 is placed on a flat carrier stage 8 and is adsorbed in vacuum so as not to deviate in the process of being coated.

The quantitative pump 15 starts supplying the coating head 5 with the coating liquid, and, immediately or after a fixed period of time has elapsed, the coating head 5 or the carrier stage 8 is moved in parallel. Just when reaching an edge of the member to be coated, the quantitative pump 15 stops supplying the coating liquid, and the movement of the coating head 5 or the carrier stage 8 is also halted. Thus, the coating process is effected to form a thin layer (coated layer 6) with a uniform thickness distribution.

If the coating process halts for a fixed period of time, with an intention of preventing the coating liquid from being solidified at the tip of the coating head 5, the supply of the coating liquid is stopped by closing the opening/closing valve 13 and halting the operation of the quantitative pump 15, and further a supply of the rinsing liquid to the coating head 5 is started by opening the opening/closing valve 23. The coating liquid reserved inside the coating head 5 is gradually extruded by the rinsing liquid, with the result that the manifold 53 and the slit 54 in the coating head 5 are filled with the rinsing liquid. The coating liquid extruded by the rinsing liquid is discharged. Just when the coating liquid within the coating head 5 is well replaced with the rinsing liquid, the opening/closing valve 23 is closed. With this rinsing operation, the coating liquid exposed to the outside air at the tip of the coating head and the coating liquid gelled inside the slit, are rinsed away.

For the duration of the stop of the coating process, it is more preferably that a small quantity of rinsing liquid be periodically, as the necessity may arise, supplied to the coating head 5 by opening the opening/closing valve 23 in order to prevent the tip of the coating head 5 from being dried.

When the coating process resumes, the opening/closing valve 23 is kept closed, the opening/closing valve 13 of the coating liquid supply circuit is opened, and the quantitative pump 15 starts operating. The quantitative pump 15 is consecutively operated, then the coating liquid is supplied until the rinsing liquid inside the coating head 5 is sufficiently replaced with the coating liquid, and the operation of the quantitative pump 15 is stopped by closing the opening/closing valve 13.

Thus, the coating liquid is prevented from being solidified and gelled inside the slit 54 as well as at the tip of the coating head 5, and the coating process can resume smoothly without causing a decline of a coating quality.

The coating method of the present invention is applied preferably to a process of manufacturing a color filter defined as a constructive member of a liquid crystal color display device. Normally, the color filter is constructed of a transparent substrate on which formed are a light shielding layer composed of a black metal or black resin known as a black matrix or a black stripe, a coloring layer having coloring pixels of three primary colors such as R (red), G (green) and B (blue) with light shielding layer openings being used for the coloring pixels, and a protection layer provided as the necessity may arise. Accordingly, the coating device of the present invention is used for coating a resist used for forming the light shielding layer, the coloring layer and the protection layer by coating, or used for patterning of the coated layers, thereby making it possible to form the coated layer having a broad effective area and a uniform thickness and also to manufacture the preferable color filter with a high yield.

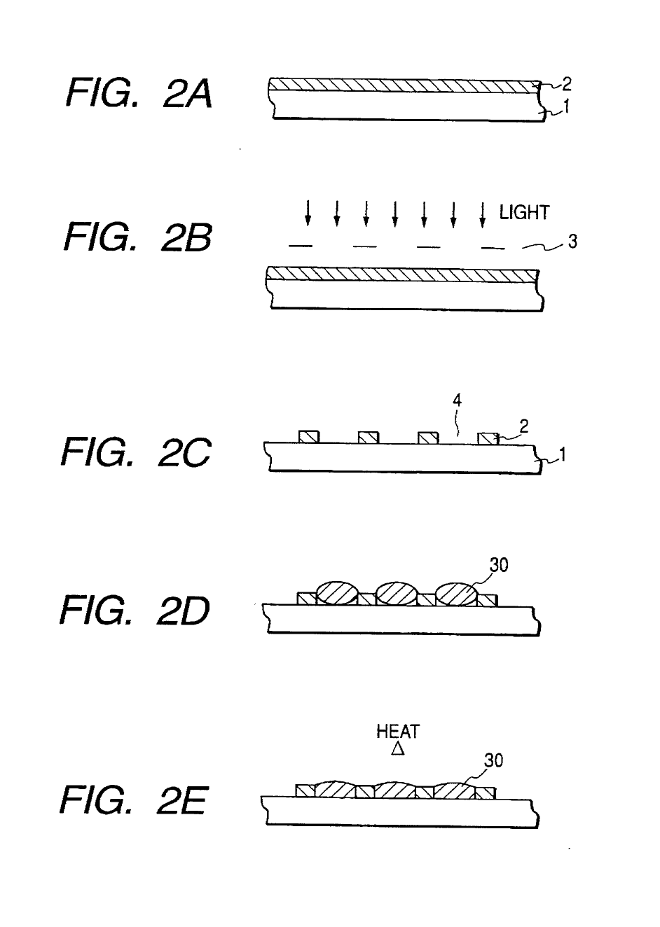

The color filter can be manufactured by, for instance, a series of processes as shown in FIGS. 2A-2E. Note that FIGS. 2A-2E correspond to processes (a)-(e) which follow.

(a) A photosensitive resinous composition 2 in black is coated over the transparent substrate 1 by the coating method of the present invention. The coated layer is thick enough to obtain a light shielding property required, and this thickness is on the order of, e.g., 1 μm. Note that the transparent substrate involves the use of, e.g., glass in many cases, however, a plastic film and a plastic sheet may also be used. Further, as the case may be, a thin layer for enhancing an adhesion may be previously formed on the transparent substrate in order to increase the adhesion between the transparent substrate, the black matrix and coloring inks.

(b) The coated layer is tentatively hardened by use of, e.g., a hot plate, and exposed to the light by use of an exposure apparatus having a wavelength matching with a sensitivity of the photosensitive resinous composition, and a mask 3 having a predetermined pattern.

(c) A developing process is executed, and, if being a negative type, the layer shielded from light by the mask 3 is eluted by a liquid developer when it is exposed to light, with the result that the substrate surface is exposed and the exposed area is left as a black matrix pattern. Subsequently the liquid developer is rinsed away, and the drying process is simply executed by a spin dry, an air knife, etc. With this drying process, the substrate surface between black matrix gap areas 4 becomes a clean surface.

(d) An ink 30 in a predetermined color is so applied as to fill in the black matrix gap areas 4. A method of applying the ink may involve the use of typical printing methods such as offset printing, gravure, screen printing, etc. Particularly, an ink jet printing method using an ink jet printing machine, however, does not employ a plate in the printing process, and is therefore preferable in terms of being capable of performing high-accuracy patterning with controlling a diameter of an ink droplet. The inks, which tend to be repelled on the black matrix pattern but permeate on the pixel areas in the black matrix gap areas, are properly selected for use herein. A surface energy (surface tension) is normally on the order of 30-70 dyne/cm. The inks described above may come under either dye series or pigment series, and a solvent is composed mainly of water and may contain an organic solvent exhibiting a water solubility.

It is preferable in terms of being capable of performing the hardening of the ink and main hardening of the black matrix in the same process that inks exhibiting a thermosetting property be used.

A material hardened under a temperature condition substantially equal to the condition for the main hardening of the black matrix, is preferable as a thermosetting component contained in the ink. The thermosetting components may be an acrylic series resin, an epoxy series resin, a phenol series resin, enthyol etc., which can be properly selected for use. Further, the above resin containing aromatic amine series and acid anhydride are contained in the above resin in accordance with a process temperature required, may also be used.

(e) The heat drying treatment (the post-baking) is executed in order to main-cure the black matrix to form the black matrix. At this time, the main curing of the ink is also preferably carried out. Thereafter, if necessary, the protection film is formed using the application system of the present invention.

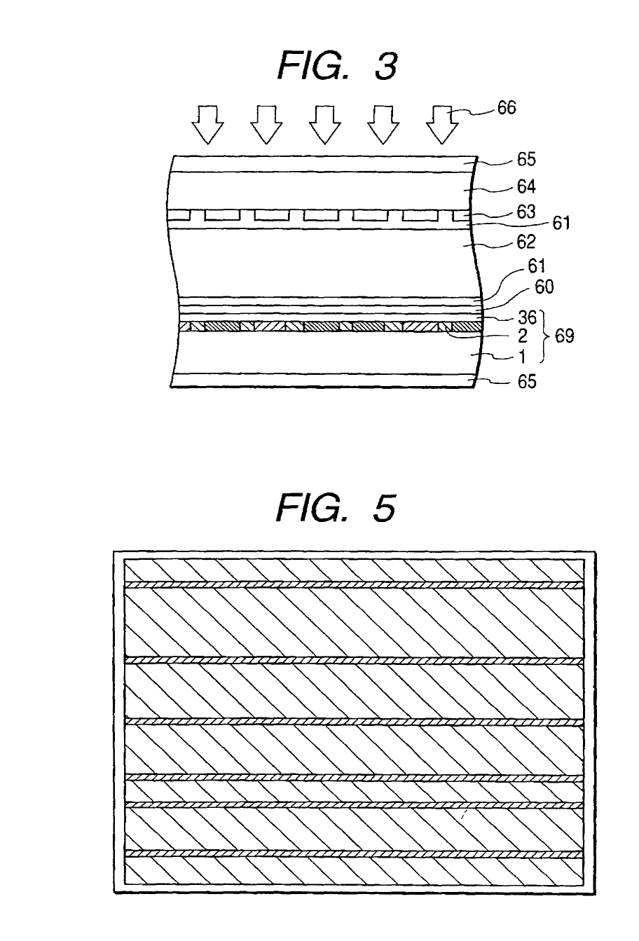

FIG. 3 shows a section of a TFT color liquid crystal panel incorporating the color filter based on the coating method according to the present invention. It is to be noted that a form thereof is not limited to what is exemplified in this embodiment.

The color liquid crystal panel is typically constructed by matching the color filer substrate 1 with a face-to-face substrate 64 and sealing a liquid crystal composition 62 therebetween. TFTs (not shown) and transparent pixel electrodes 63 are formed in matrix inwardly of one substrate 64 of the liquid crystal panel. Further, a color filter substrate 69 is provided inwardly of the other substrate 1 so that RGB color materials are arranged in positions facing to the pixel electrodes. A transparent face-to-face electrode (common electrode) 60 is provided on one surface of the color filter substrate 69. The black matrix is normally formed on the side of the color filter substrate. Moreover, an orientation layer 61 is formed within the plane between the two substrates and subjected to a rubbing process, whereby liquid crystal molecules can be arrayed in a fixed direction. Further, a polarizing plate 65 is bonded to an external portion of each glass substrate, and a liquid crystal compound 62 fills in a gap (on the order of 2-5 μm) between those glass substrates. Moreover, a combination of a fluorescent lamp not shown) and a scattering plate (not shown) is generally used as a back light, and the liquid crystal compound functions as an optical shutter for varying a transmissivity of a beam of the back light, thus performing the display. A protection layer designated by 36 may be provided according to the necessity.

Embodiments of the present invention and comparative examples thereof will hereinafter be described.

(Embodiment 1)

SS-6699G (made by JSR Corp.) categorized as a 2-liquid type thermosetting resin is adopted as a coating liquid, and a no-alkali glass substrate 1737 (made by Corning Corp.) having a dimension of 360 mm×465 mm×0.7 mm is used as a member to be coated. The coating process is executed by a coating device having a construction as shown in FIG. 1.

The quantitative pump 15 involves the use of a high-accuracy diaphragm pump. A high-accuracy servo motor is used for driving the substrate carrier stage 8.

The coating liquid SS-6699G is set in a coating liquid tank 11, and a liquid supply circuit extending to the coating head 5 is filled beforehand with the coating liquid.

Herein, a rinsing liquid tank 21 is filled with propylene glycol mono-methyl ether acetate (which is hereinafter be called a rinsing liquid), then a pressurizing container 25 is supplied with the air pressurized at 0.4 kgf/cm² by a pressurizing pump (not shown), and an opening/closing valve 23 is opened for 2 min. The coating liquid in the coating head 5 is thereby replaced with the rinsing liquid. In this state, the coating head is left as it is for 24 hours. In the meantime, the opening/closing valve 23 is opened for 5 sec at an interval of 20 min, and the coating head 5 is periodically supplied with the rinsing liquid, thereby preventing the tip of the coating head 5 from being dried.

After a 24-hour elapse, a fresh coating liquid is set in the tank 11, then the opening/closing valve 13 is opened, and the quantitative pump 14 is consecutively operated for 3 min, thereby replacing the rinsing liquid in the coating head 5 with the coating liquid.

Thereafter, the coating process which will hereinafter be shown is executed.

A slit gap is set to 30 μm, and a distance (clearance) of the surface of the member to be coated from the tip of the coating head is set to 50 μm. Further, a crosswise width of an eject port at the front end of the slit is set to 356 mm so that the coating liquid does not flow round to the side surfaces and the underside of the member to be coated.

A substrate carrier speed is set to 52 mm/sec, a flow rate of the quantitative pump 15 is set as an eject rate to 74.1 μl/sec, and the coating process is executed so that start and end points of the coating are each 1.0 mm inward from the edge of the substrate.

The coated substrate obtained is dried for 20 min at 90° C. in an oven, and thereafter baked for 60 min at 230° C. in the oven, thereby obtaining a coated layer.

As a result of visually confirming the coated layer, it has proven that the coated layer obtained is uniform.

(Embodiment 2)

With a photosensitive resinous composition composed of acrylic series polymer shown as below being used as a coating liquid, and with ethyl Cellosolve being adopted as a rinsing liquid, the coating liquid is set in the coating liquid tank 11 in the coating device in the embodiment 1, and the liquid supply circuit extending to the coating head 5 is previously filled with the coating liquid.

[Chemical Chart 1]
Photosensitive Resinous Compositions
Terpolymer composed of:

| | |
|---|---|
| Methyl methacrylate | 5.0 parts by weight |
| Hydroxy methacrylate | 3.0 parts by weight |
| N-methylol acrylamide | 2.0 parts by weight |
| Triphenylphonium triphrate | 0.3 parts by weight |
| (TPS-105 made by Midori | |
| Chemical Co., Ltd) | |
| Ethyl Cellosolve | 89.7 parts by weight |

Herein, the rinsing liquid tank 21 is filled with the rinsing liquid, then the pressurizing container 25 is supplied with the air pressurized at 0.4 kgf/cm² by the pressurizing pump (not shown), and the opening/closing valve 23 is opened for 2 min. The coating liquid in the coating head 5 is thereby replaced with the rinsing liquid. In this state, the coating head is left as it is for 1 hour. In the meantime, the opening/closing valve 23 is opened for 5 sec at an interval of 15 min, and the coating head 5 is periodically supplied with the rinsing liquid, thereby preventing the tip of the coating head 5 from being dried.

After a 1-hour elapse, the opening/closing valve 13 is opened, and the quantitative pump 14 is consecutively operated for 3 min, thereby replacing the rinsing liquid in the coating head 5 with the coating liquid.

Thereafter, the coating process which will hereinafter be shown is executed.

The no-alkali glass substrate 1737 (made by Corning Corp.) having the dimension of 360 mm×465 mm×0.7 mm, of which the entire surface is formed with a 3-layered low reflection chrome film, is used as a member to be coated.

A slit gap is set to 30 μm, and a distance (clearance) of the surface of the member to be coated from the tip of the coating head is set to 50 μm. Further, a crosswise width of the eject port at the front end of the slit is set to 356 mm so that the coating liquid does not flow round to the side surfaces and the underside of the member to be coated.

A substrate carrier speed is set to 40 mm/sec, a flow rate of the quantitative pump 15 is set as an eject rate to 110 μl/sec, and the coating process is executed so that start and end points of the coating are each 1.0 mm inward from the edge of the substrate.

Subsequently, pre-baking is effected for 20 min at 90° C. in the oven, and the hardening process is executed at 230° C. in the oven.

As a result of observing the coated layer thus obtained, it has proven that the coated layer is uniform.

(Embodiment 3)

As a result of replacing the coating liquid filling the coating head 5 and the liquid supply circuit with the rinsing liquid in accordance with the procedure shown in the embodiment 2, a quantity of the rinsing liquid needed for the rinsing was 180 cc.

(Embodiment 4)

As a result of replacing the rinsing liquid filling the coating head 5 and the liquid supply circuit with the coating liquid in accordance with the procedure shown in the embodiment 2, a quantity of the coating liquid needed for this restoration was 140 cc.

(Embodiment 5)

The photosensitive resinous layer is formed on the glass substrate formed with the black matrix by performing the rinsing process, the leave-as-it-is process, the coating liquid replacing process and the coating process in the procedures by use of the materials which are shown in the embodiment 2.

Subsequently, the pre-baking process is executed for 20 min at 90° C., and a part of the resin layer on the black matrix is subjected to a pattern-exposure with an exposure quantity of 1 J/cm² through a photo mask formed with an opening narrower than the width of the black matrix. Further, un-exposed areas are colored in R, G and B matrix patterns with dye inks having the following compositions by use of an ink jet recording device.

[Chemical Chart 2]
Ink Compositions

| | |
|---|---|
| Dye | 5 parts by weight |
| Ethylene glycol | 10 parts by weight |
| Isopropyl alcohol | 3 parts by weight |
| Ion exchange water | 82 parts by weight |

Dyes
R: C.I.Acid Red 118
G: C.I.Acid Green 25
B: C.I.Acid Blue 113

Further, the inks are dried for 5 at 90° C. for 5 min by the hot plate, and the resin layer is hardened at 230° C. in the oven.

Subsequently, a 2-liquid type thermosetting resin SS-6699G (made by JSR Co., Ltd.) Is coated by a spinner, and is further pre-baked for 20 min at 90° C. in the oven. Moreover, the hardening process is executed for 60 min at 230° C. in the oven, thereby forming an over-coat layer having a thickness of 1 μm.

When observing the thus formed the color filter for the liquid crystal by an optical microscope, there are detected no defects such as mixed colors, ununiform colors, decoloring, etc.

Moreover, a liquid crystal panel is manufactured by use of this color filter and driven, whereby a high-definition color display can be attained.

(Comparative Example 1)

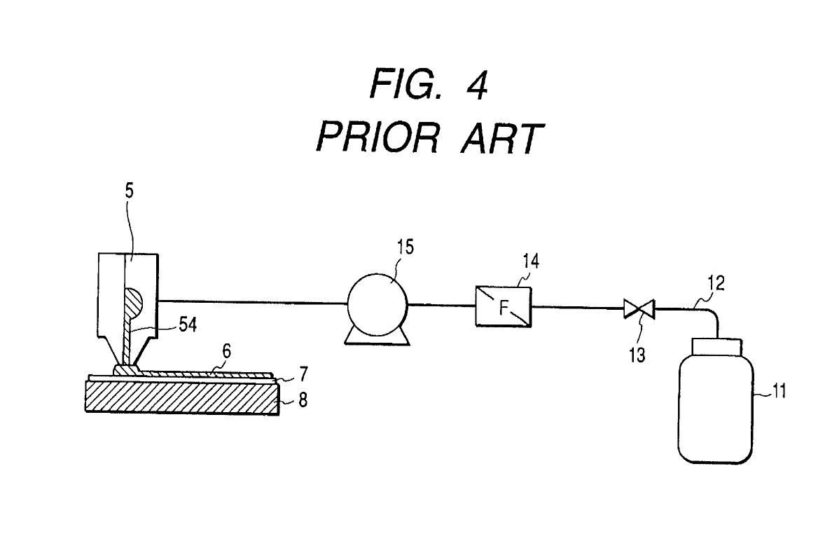

SS-6699G (made by JSR Corp.) categorized as a 2-liquid type thermosetting resin is adopted as a coating liquid, and the no-alkali glass substrate 1737 (made by Corning Corp.) having the dimension of 360 mm×465 mm×0.7 mm is used as a member to be coated. The coating process is executed by a coating device having a construction as shown in FIG. 4.

The quantitative pump 15 involves the use of a high-accuracy diaphragm pump. A high-accuracy servo motor is used for driving the substrate carrier stage 8.

The coating liquid SS-6699G is set in the coating liquid tank 11, and the liquid supply circuit extending to the coating head 5 is filled beforehand with the coating liquid.

Herein, a 24-hour leave-as-it-is process is executed in this state.

After a 24-hour elapse, the following coating process is carried out.

slit gap is set to 30 μm, and a distance (clearance) of the surface of the member to be coated from the tip of the coating head is set to 50 μm. Further, a crosswise width of an eject port at the front end of the slit is set to 356 mm so that the coating liquid does not flow round to the side surfaces and the underside of the member to be coated.

A substrate carrier speed is set to 52 mm/sec, a flow rate of the quantitative pump 15 is set as an eject rate to 74.1 μl/sec, and the coating process is executed so that start and end points of the coating are each 10 mm inward from the edge of the substrate.

The coated substrate obtained is dried for 20 min at 90° C. in the oven, and thereafter baked for 60 min at 230° C. in the oven, thereby obtaining a coated layer.

As a result of visually confirming the coated layer, it has proven that the coated layer has partially, as shown in FIG. 5, uncoated stripes as a defect.

(Comparative Example 2)

With the photosensitive resinous composition used in the embodiment 2 serving as a coating liquid, and with ethyl Cellosolve being adopted as a rinsing liquid, the coating liquid is set in the coating liquid tank 11 in the coating device in the comparative example 1, and the liquid supply circuit extending to the coating head 5 is previously filled with the coating liquid.

Herein, a 1-hour leave-as-it-is process is carried out in this state.

Thereafter, the coating device executes the coating process by use of the same member to be coated under the same coating conditions as those in the embodiment 2.

As a consequence of observing the coated layer under a low pressure sodium lamp, striped ununiform areas are detected in the coating direction.

(Comparative Example 3)

The circuit extending from the coating tank 11 to the coating head 5 is filled with the coating liquid in the embodiment 2 in the coating device used in the comparative example 1. Herein, the liquid in the coating tank 11 is exchanged with the rinsing liquid used in the embodiment 2, then the opening/closing valve 13 is opened, and the quantitative pump 15 is consecutively operated at an eject rate of 3,000 μl/sec for 8 min until the coating liquid in the coating head is sufficiently replaced with the rinsing liquid, with the result that a quantity of the rinsing liquid needed for this rinsing process was 970 cc.

(Comparative Example 4)

The circuit extending from the coating tank 11 to the coating head 5 is filled with the rinsing liquid in the embodiment 2 in the coating device used in the comparative example 1. Herein, the liquid in the coating tank 11 is exchanged with the coating liquid used in the embodiment 2, then the opening/closing valve 13 is opened, and the quantitative pump 15 is consecutively operated at an eject rate of 3,000 μl/sec for 6 min until the rinsing liquid in the coating head is sufficiently replaced with the coating liquid, with the result that a quantity of the rinsing liquid needed for this rinsing process was 730 cc.

(Comparative Example 5)

The photosensitive resinous layer is formed on the glass substrate formed with the black matrix by performing the rinsing process, the leave-as-it-is process, the coating liquid replacing process and the coating process in the procedures by use of the materials which are shown in the comparative example 2.

Based on the method exemplified in the embodiment 2, the color filter is obtained by executing the pre-baking, the pattern-exposure, the pattern-coloring, the resin layer hardening process and the formation of the over-coat layer.

As a consequence of observing the thus manufactured color filter for the liquid crystal by the optical microscope, a defect such as ununiformity in color is detected in the longitudinal direction of the substrate.

An operation time for rinsing the coating head and performing a maintenance thereof can be reduced by use of the coating method or the coating device according to the present invention, and the quantity of the rinsing liquid used can be also decreased.

Moreover, the method of manufacturing the color filter according to the present invention enhances an equipment working ratio and enables the high-quality color filter with a high yield.

What is claimed is:

1. A coating method of ejecting a coating liquid over the surface of a member to be coated and thus forming a coated layer thereon by relatively moving a coating head and said member to be coated, comprising:
a step of rinsing said coating head by stopping a supply of the coating liquid to said coating head after ejecting the coating liquid, and making a rinsing liquid flow directly to said coating head or toward said coating head from midway of a coating liquid supply path extending to said coating head.

2. A coating method according to claim 1, further comprising a step of supplying the rinsing liquid trace by trace or intermittently to said coating head.

3. A coating device comprising:
a coating liquid supply device;
a coating head for ejecting a coating liquid from said coating liquid supply device; and
a stage for holding a member to be coated, wherein a first liquid circuit for supplying the coating liquid and a second liquid circuit for supplying a rinsing liquid to said coating head are provided.

4. A method of manufacturing a color filter substrate, comprising:
a step of coating a photosensitive resinous composition over a substrate by said coating method according to claim 1;
a step of obtaining a black matrix pattern by forming a pattern on said photosensitive resinous composition; and
a step of applying a coloring ink so as to fill in a black matrix pattern gap.

5. A liquid crystal display device comprising:
a color filter substrate manufactured by said method according to claim 4;
a face-to-face substrate disposed facing to said color filter; and
a liquid crystal composition sealed in between said color filter substrate and said face-to-face substrate.
